(19) United States
(12) Patent Application Publication
(10) Pub. No.: US 2018/0277844 A1
(43) Pub. Date: Sep. 27, 2018

(54) Production of a Spinel Material

(71) Applicant: CSIR, Pretoria (ZA)

(72) Inventors: Kenneth Ikechukwu Ozoemena, Pretoria (ZA); Funeka Nkosi, Germiston (ZA)

(21) Appl. No.: 15/522,979

(22) PCT Filed: Oct. 30, 2015
(86) PCT No.: PCT/ZA2015/050019

§ 371 Date: Apr. 28, 2017

(30) Foreign Application Priority Data
Oct. 31, 2014 (ZA) 2014/07986

(51) Int. Cl. H01M 4/505; C01G 45/12; H01M 10/0525; H01M 10/058

(52) U.S. Cl. CPC H01M 4/505; C01G 45/1242; H01M 10/0525; H01M 10/058; C01P 2002/32; C01P 2006/40; H01M 2004/028; C01P 2004/03; C01P 2004/04; C01P 2002/72; C01P 2002/85; C01P 2002/82; C01P 2002/54

(57) ABSTRACT

A process for producing a lithium-manganese-oxide spinel material includes producing a raw lithium-manganese-oxide (‘LMO’) material by means of combustion synthesis; optionally, subjecting the raw LMO material to microwave treatment, to obtain a treated material; annealing the raw LMO material or the treated material, to obtain an annealed material; and optionally, subjecting the annealed material to microwave treatment. At least one of the microwave treatments must take place.

THIS INVENTION relates to the production of a spinel material. More particularly, it relates to a process for producing a lithium-manganese-oxide spinel material, and to a electrochemical cell which includes such material.

Rechargeable lithium ion batteries (RLIBs) have proved themselves as the most attractive advanced battery technologies for electric vehicles and portable electronics. In particular, the lithium manganese oxide, LiMn₂O₄ (LMO) spinel material has proved itself as one of the most attractive cathode material for RLIBs due to its high operating voltage (4 V), low cost, environmental compatibility, and stability at low temperature compared to other cathode materials. LMO has begun to show some commercial success; it is the cathode material that drives pure electric and plug-in hybrid electric vehicles.

Despite the advantages of LMO, the biggest problem that still conspires against its full utilization is capacity fading upon cycling. The capacity loss is caused by two main factors, viz. Jahn-Teller distortion and slow dissolution of manganese in the electrolyte. The Jahn-Teller effect is the reduction of the crystal symmetry from cubic (c/a=1.0) to tetragonal (c/a˜1.16), increasing the c/a ratio of unit cell by 16%. It is this structural transition that deteriorates its cycle life and is said to occur when the average Mn oxidation state is 3.5. The stress generated by this phenomenon may lead to the cracking of particles and loss of electric contact loss upon cycling.

The second reason for capacity fade is the slow dissolution of manganese (Mn³⁺ ion) into the electrolyte following the disproportionation reaction (1):

2Mn³⁺+→Mn⁴⁺+Mn²⁺ (1)

The disproportion reaction of Mn³⁺ ions produces Mn²⁺ ions which dissolve in the electrolyte. This dissolution can cause the loss of active material and also affect the performance of the anode. The anode can be plated with the solvated Mn²⁺ ions and the Li ions will be depleted in the anode, since the reduction of Mn will oxidize Li from the anode [14].

In general, the capacity fade in LMO is related to the high concentration of Mn³⁺ in the spinel structure. In the spinel LMO, the manganese ions are believed to exist as 50% Mn³⁺ and 50% Me (i.e., average manganese valence, n_{Mn}=3.5+). The Mn⁴⁺ ions are redox-inactive and so do not contribute to the electrochemistry of the LMO but assist in stabilising the spinel structure. The Mn³⁺ ions are redox-active and more conducting than the Mn⁴⁺ ions. Despite the importance of the Mn³⁺ ions to the electrochemistry of the spinel cathode materials, they remain the major contributor to capacity fade of the LMO. It is generally accepted that the when the concentration of Mn³⁺ ions exceeds that of Mn⁴⁺ ions (n_{Mn}<3.5+) the Jahn-Teller distortion becomes prominent. High content of Mn³⁺ ions causes the Jahn-Teller distortion, and leads to the dissolution of the cathode material into the electrolyte. It is believed that the best valence for doped LMO is >3.6+.

Hitherto, the Applicant has been aware of only three means of improving the cycling performance of LMO, viz.; (i) making the spinel structure lithium-rich (Li-excess), (ii) doping the spinel structure with different cations and anions, and (iii) coating the spinel structure with metal oxides (such as Y₂O₃). Aluminium (Al) is a favourable dopant since it is abundant, non-toxic, less expensive and lighter than transition metal elements. The Applicant is also aware that Al-doped spinel LMO (LiAlₓMn₂₋ₓO₄) shows enhanced electrochemical performance over pure LMO. Al is redox-inactive dopant; it assists in stabilising the structure, but does not improve the discharge capacity.

It is hence an object of this invention to provide a LMO spinel material whereby the cycling performance of electrochemical cell containing such material as cathode material, can be improved.

Thus, according to a first aspect of the invention, there is provided a process for producing a lithium-manganese-oxide spinel material, which includes
producing a raw lithium-manganese-oxide (IMO′) material by means of combustion synthesis;
optionally, introducing a dopant capable of enhancing the performance of the LMO spinel material when used as a cathode material in an electrochemical cell;
optionally, subjecting the raw LMO material to microwave treatment, to obtain a treated material;
annealing the raw LMO material or the treated material, to obtain an annealed material; and
optionally, subjecting the annealed material to microwave treatment; with the proviso that at least one of the microwave treatments takes place, thereby to obtain the lithium-manganese-oxide (LMO) spinel material.

By ‘combustion synthesis’ is meant self-propagating high-temperature synthesis which comprises subjecting a mixture of reactants to an initial high temperature to initiate an exothermic reaction of the reactants throughout the mixture. More particularly, solution combustion synthesis may be employed. Solution combustion synthesis (‘SCS’) comprises subjecting or exposing a homogeneous solution of reactants to an initial high temperature to initiate an exothermic reaction of the reactants throughout the solution. The reaction is thus a self-sustaining reaction, and a powdered or granular product is typically obtained as a product. The product granules or particles may be in the nanometer scale range, i.e. may have diameters or cross-sectional dimensions of 1-100 nm.

The reactants will thus comprise a lithium compound and a manganese compound. The compounds must be able to function as oxidizers for the exothermic reaction and must naturally also be soluble in the solvent used to form the homogeneous solution, when SCS is employed. Thus, nitrates, acetates, sulphates and carbonates of lithium and manganese can be used; however, lithium nitrate (LiNO₃) and manganese nitrate (particularly Mn(NO₃)₂.4H₂O) are preferred as the reactants when SCS is used to produce the raw powdered/granular LMO material. The raw LMO material is hence produced by means of a solid state method.

The solvent used in the solution may be water. The mixture of reactants or the homogeneous solution may include a combustion aid or fuel for the reaction. The fuel may be an organic fuel, and may be urea, glycine, a hydrazide, sucrose or citric acid; however, urea is preferred.

The solution may thus be an aqueous solution. The process may accordingly include dissolving the lithium compound, the manganese compound and the urea in water. The initial high or elevated temperature to which the solution is subjected or exposed may be at least 500° C., preferably about 550° C. It is believed that a temperature of about 600° C. is a practical upper limit for the high temperature to which the solution is initially subjected or exposed. Thus, the Applicant has found that at temperatures below 500° C., the exothermic reaction simply does not initiate, or takes place at a too slow rate, while at temperatures above 550° C., and particularly above 600° C., the effect of the subsequent microwave treatment becomes less pronounced and even insignificant.

The solution and the product (as it forms) can continue to be subjected to the high temperature of 500° C. to 600° C. while the exothermic or self-sustaining reaction takes place, i.e. until the reaction ceases (no more product formation). Naturally, however, the high temperature exposure can be ceased, if necessary, once the self-sustaining or exothermic reaction has commenced, e.g. if required for temperature control or for any other purpose.

SCS is a technique for producing powdered/granular product rapidly, simply and effectively. As indicated, the exothermic reaction will endure until the product is fully formed, i.e. until no more reactant (particularly fuel) remains to partake in the exothermic reaction. Typically the reaction time, i.e. the time from when the solution is first exposed to the elevated or high temperature up to when no further product forms, is in the range of 7-12 minutes.

The exothermic reaction may be effected at atmospheric pressure.

In one embodiment of the invention, no dopant or any other element will be present in the solution to any appreciable extent so that the raw material is simply a raw lithium-manganese-oxide material.

However, in another embodiment of the invention, the dopant, which may in particular be aluminium, may be present. The solution will then contain a dissolved aluminium compound, which may be aluminium nitrate, particularly Al(NO₃)₂.9H₂O.

The microwave treatment or irradiation may comprise subjecting the raw LMO material and/or the annealed material to microwaves (typically at λ=0.12236 m, 600 W) for between 10 and 30 minutes, e.g. for about 20 minutes. The microwave power may, however, be less than or greater than 600 W.

The annealing of the raw LMO material or the treated material may be effected at a temperature which is sufficiently high to crystallize the material. Thus, the annealing may be effected at a temperature from 600° C. to 800° C., e.g. at about 700° C. The annealing may be effected for a period of time which is long enough to achieve a desired degree of annealing, i.e. to achieve a desired degree of crystallinity. Typically, the annealing will take from 8 to 12 hours, e.g. about 10 hours.

The invention extends also to a LMO spinel material when produced by the process of the first aspect of the invention.

According to a second aspect of the invention, there is provided an electrochemical cell, which includes a cell housing, a cathode, an anode and an electrolyte in the cell housing, in which the cathode is electronically insulated from the anode but electrochemically coupled thereto by the electrolyte, the cathode comprising the LMO spinel material produced by the process of the first aspect of the invention.

The cathode may comprise the LMO spinel material, carbon black, and a binder, e.g. polyvinylidene fluoride, in a solvent, such as N-methyl-2-pyrrolidone.

The anode may comprise lithium metal.

The electrolyte may be a non-aqueous electrolyte, e.g. It may be, or may include, LiPF₆.

The cell housing, cathode, anode and electrolyte may be arranged to permit a charging potential to be applied to the cell to cause lithium from the cathode to form at least part of the anode, and with the cell being such that during charge and discharge hereof, the average manganese valence state is about 3.5+ or higher, for example 3.8+ or higher.

According to a third aspect of the invention, there is provided a method of making an electrochemical cell, which includes loading, into a cell housing, an electrolyte, an anode and cathode, with the cathode comprising the LMO spinel material produced by the process of the first aspect of the invention.

According to a fourth aspect of the invention, there is provided a method of operating an electrochemical cell, which method includes
applying a charging potential to the electrochemical cell of the second aspect of the invention, thereby causing lithium from the cathode to form at least part of the anode; and
permitting the discharging potential of the cell to reach 3.5 to 4.3 V vs. lithium metal, and with the average manganese valence state being about 3.5+ or higher during charge and discharge of the cell.

The discharging potential of the cell may be permitted to reach 3.8 to 4.2 V vs lithium metal. The average manganese valence state may be about 3.8+ or higher during charge and discharge of the cell.

The invention will now be described in more detail with reference to the accompanying drawings.

In the drawings

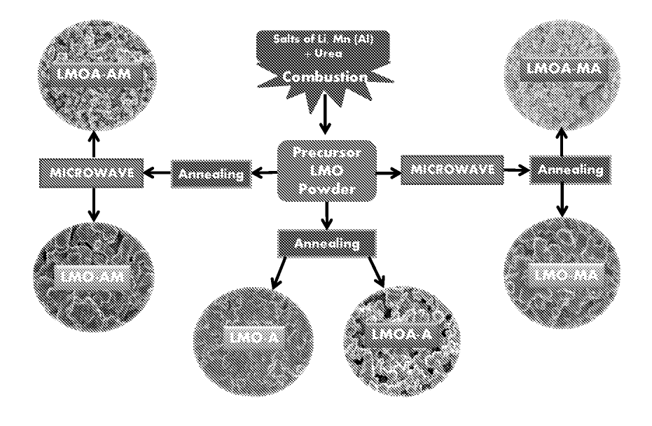

FIG. 1 shows, for the Example, a schematic representation of the microwave assisted solution combustion synthesis (‘SCS’) preparation of LiMn₂O₄ (LMO) and LiMn_{1.7}Al_{0.3}O₄ (LMOA);

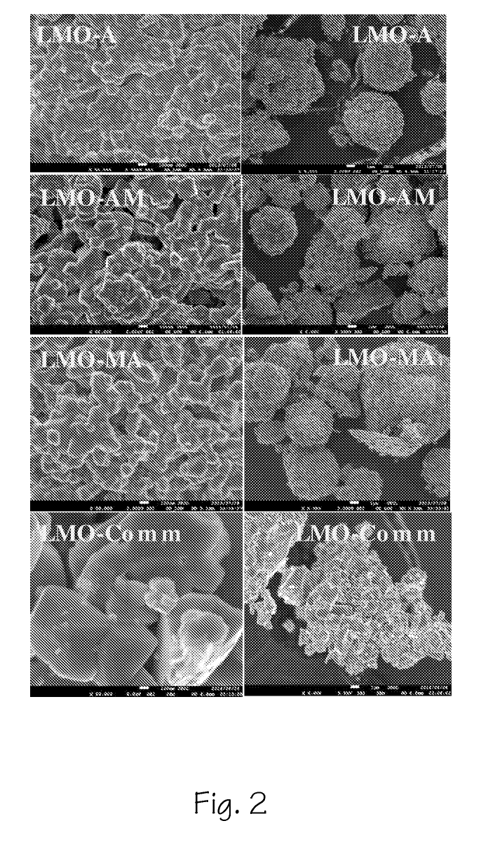

FIG. 2 shows, for the Example, typical SEM images of LMO powders at different magnifications (100 nm and 1 μm respectively);

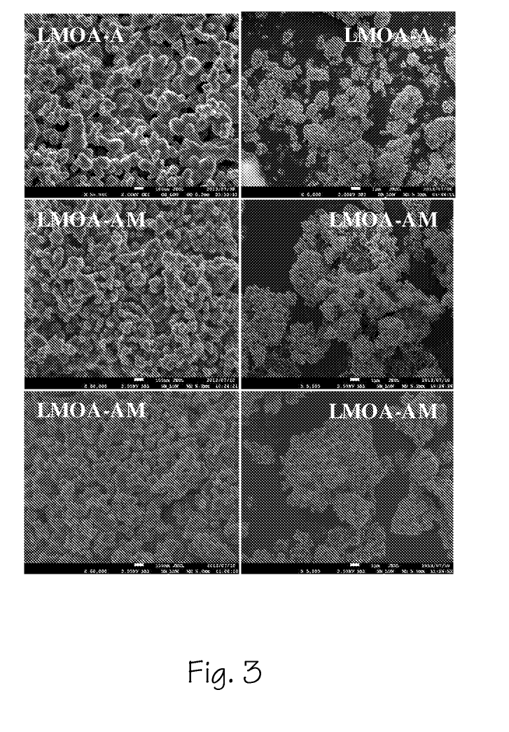

FIG. 3 shows, for the Example, typical SEM images of LMOA powders at different magnifications (100 nm and 1 μm respectively);

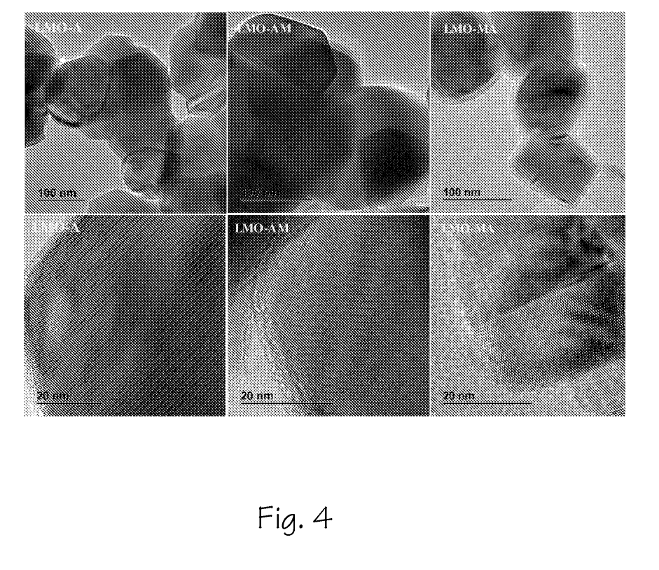

FIG. 4 shows, for the Example, TEM images of (a) LMO-A, (b) LMO-AM and (c) LMO-MA cathode materials, and their corresponding HRTEM images;

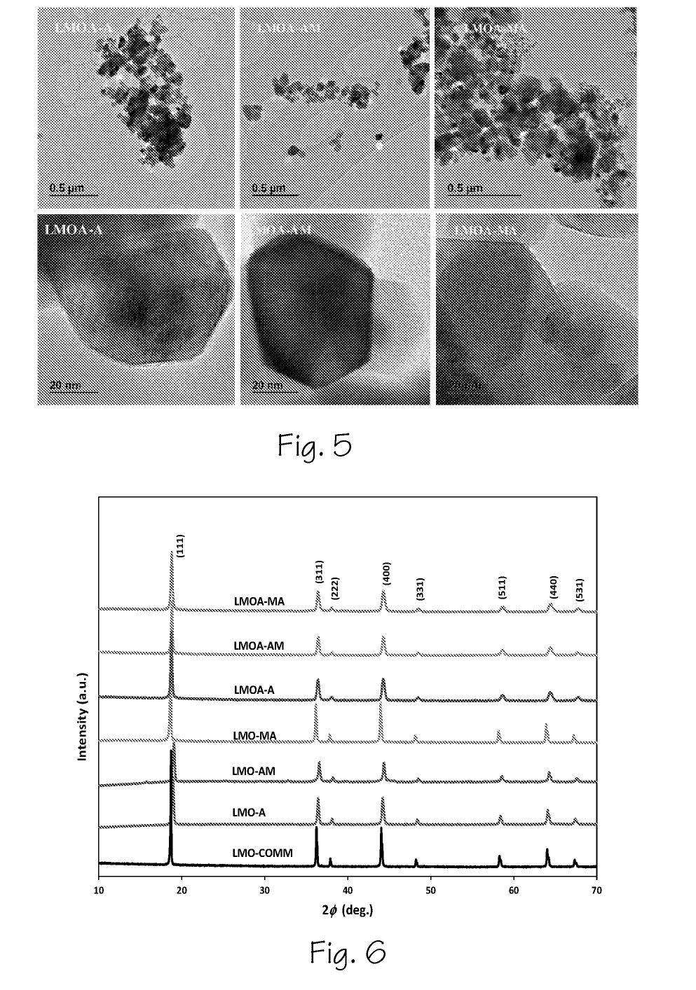

FIG. 5 shows, for the Example, TEM images of LMOA-A, LMOA-AM and LMOA-MA cathode materials, and their corresponding HRTEM images;

FIG. 6 shows, for the Example, XRD patterns of LMO and LMOA powders;

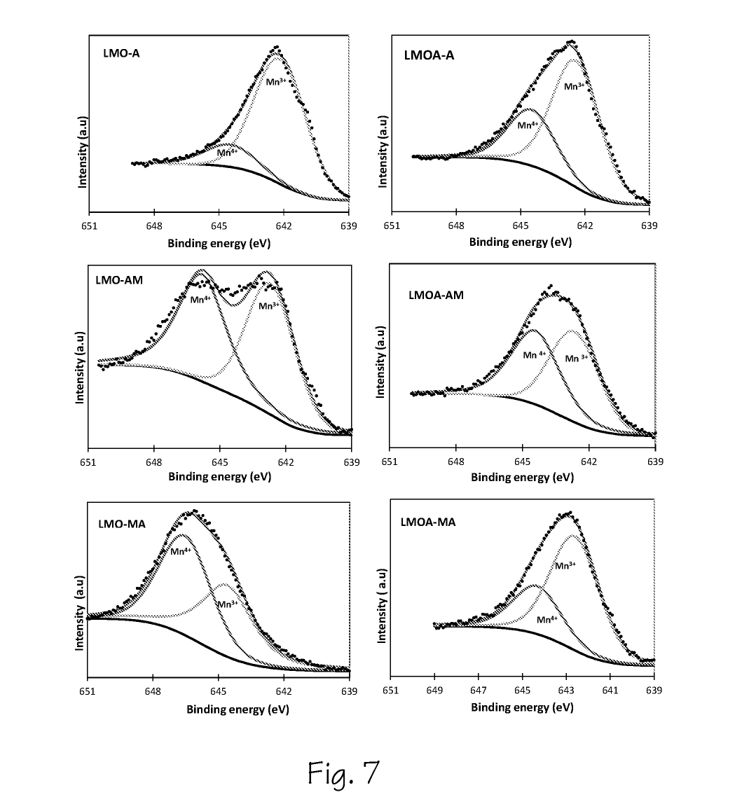

FIG. 7 shows, for the Example, XPS Mn 2p_{3/2} spectra of LMO and LMOA samples;

FIG. 8 shows, for the Example, raman spectra of LMO and its Al-doped counterparts;

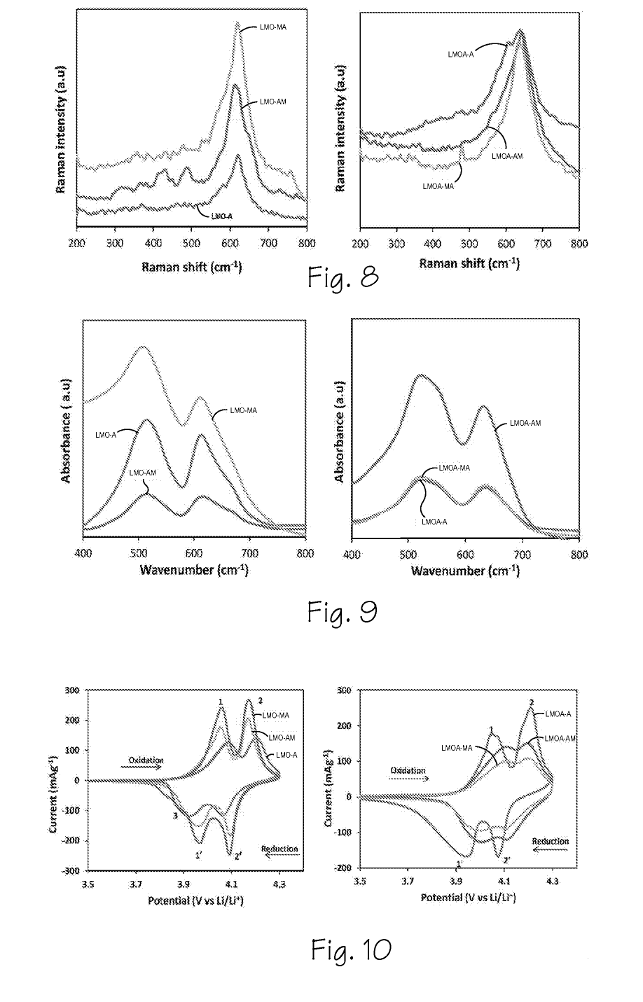

FIG. 9 shows, for the Example, FTIR spectra of LMO and LOA powders;

FIG. 10 shows, for the Example, cyclic voltammograms of LMO and LMOA powders at 0.1 mVs⁻¹ at room temperature;

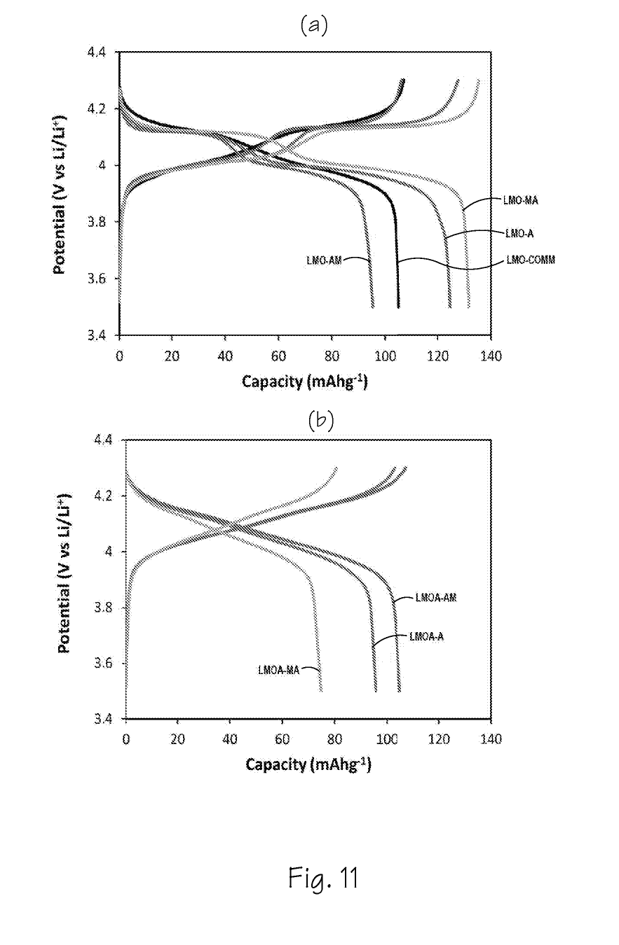

FIG. 11 shows, for the Example, galvanostatic charge-discharge of LMO and LMOA powders at 0.1 C at room temperature;

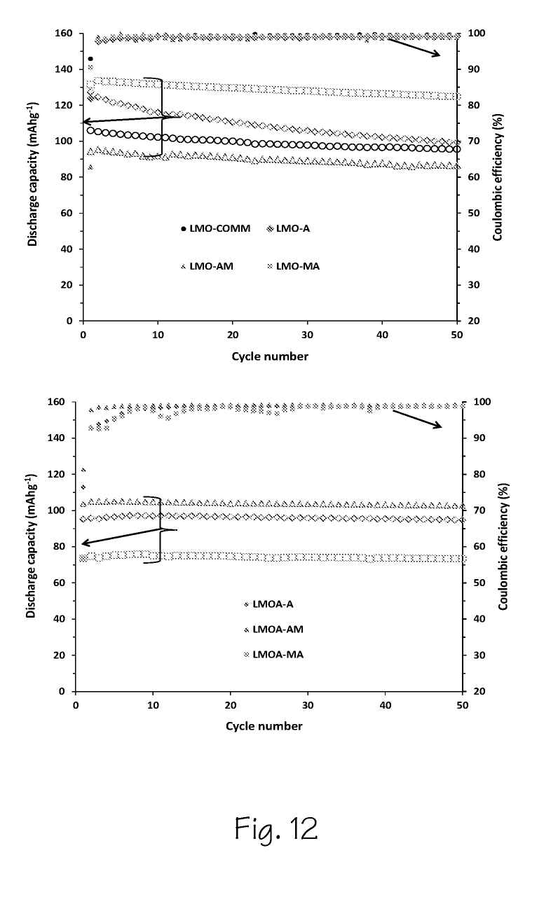

FIG. 12 shows, for the Example, discharge capacity and coulombic efficiency vs cycle number graphs for different LMO and LMOA based coin cells;

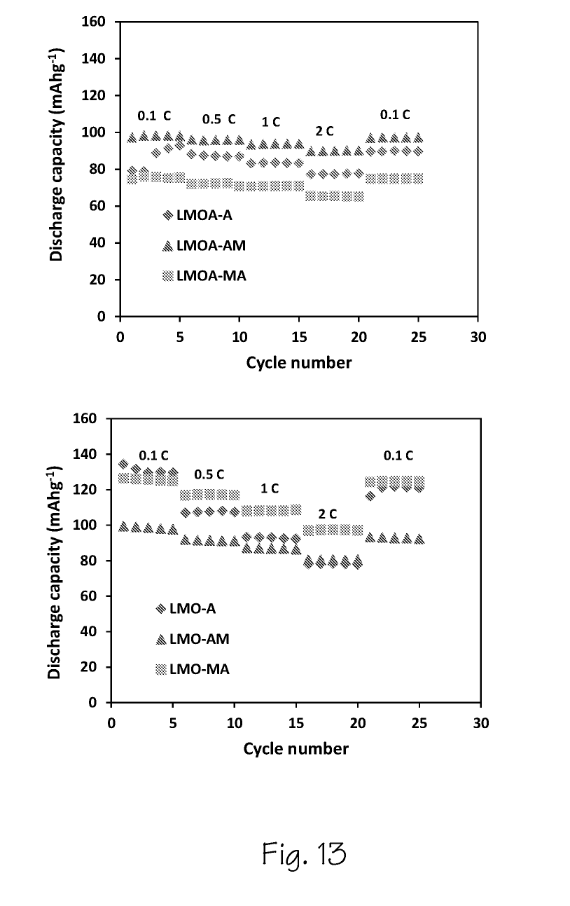

FIG. 13 shows, for the Example, the capacity vs cycle number plots for the LMO and Al-doped LMO at different current densities (0.2-2 C) at room temperature between 3.5-4.3 V range;

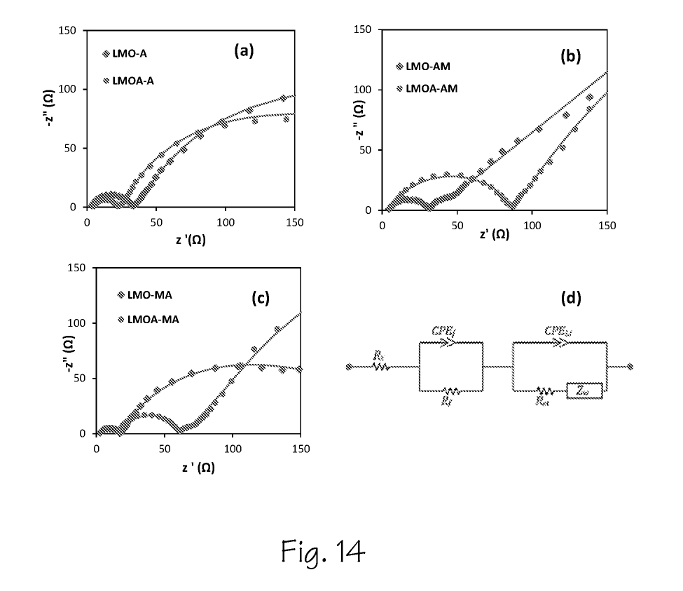

FIG. 14 shows, for the Example, Cole-Cole (Nyquist) plots of LMO and LMOA based coin cells with (d) being the equivalent circuit used in fitting the spectra; and

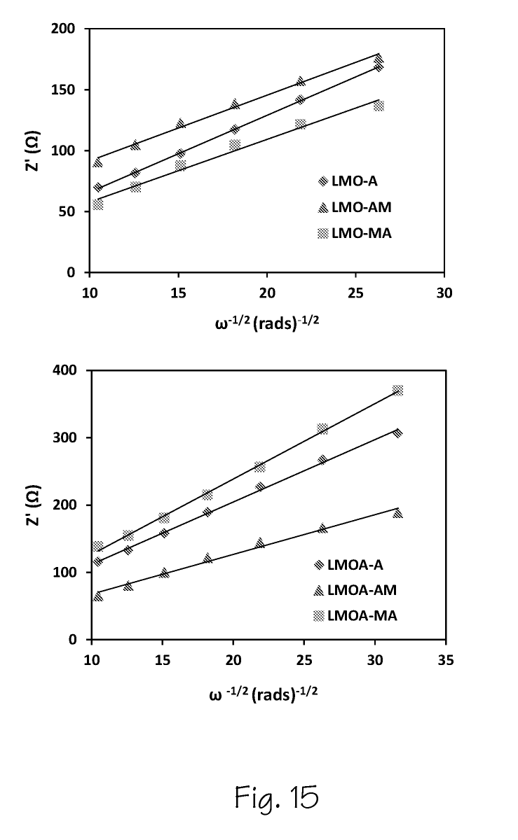

FIG. 15 shows, for the Example, Z′ vs ω^{-1/2} curves for LMO and LMOA based coin cells.

### EXAMPLE

### Experimental Section

### Chemicals and Materials

Lithium nitrate (LiNO₃), Manganese nitrate tetrahydrate (Mn(NO₃)₂.4H₂O), Urea (CO(NH₂)₂) and aluminum nitrate nonahydrate (Al(NO₃)₂.9H₂O), were purchased from Sigma-Aldrich. Carbon black, N-methyl-2-pyrrolidone (NMP), polyvinylidene fluoride (PVDF), aluminum foil (MTI Corporation USA, 50 μm thick), lithium metal (Sigma-Aldrich, 50 μm thick), Lithium hexafluorophosphate (LiF₆P), ethylene carbonate (EC), diethyl carbonate (DEC), and dimethyl carbonate (DMC) were used during preparation of the LMO cathodes and fabrication of coin cells. These chemicals were also purchased from Sigma-Aldrich. All these chemicals were used without further purification.

### Synthesis of LMO and Al-Doped LMO Powders

A solution combustion synthesis method, was used to synthesize spinel LMO-based powders directly from lithium nitrate, manganese nitrate and urea. LiNO₃ (1.10 g, 0.0398 mol.), Mn(NO₃)₂.4H₂O (8.00 g, 0.0797 mol.) and urea (2.87 g, 0.120 mol.) were dissolved in deionised water (20.00 ml) and stirred until the starting materials were completely dissolved. The resultant solution was heated in the furnace at 550° C. for ˜7 minutes to give a black powder product in the nanoparticle size range. The powders were ground using pestle and mortar before subjecting them to the heat treatments below. To study the impact of microwave irradiation, two batches of the powders were synthesized. These powders were subjected to microwave irradiation (using the Anton Paar Multiwave 3000 system, λ=0.12236 m) at 600 W for 20 min before and after annealing, respectively. The sample powders were annealed at 700° C. for 10 h using a tube furnace (50 mm, MTI Corporation). The powders obtained were lithium manganese dioxide-microwaved and then annealed (LMO-MA) and lithium manganese dioxide—annealed and then microwaved (LMO-AM). The LMO powder sample that was only annealed was named LMO-A. The LMO aluminum doped powders were prepared using the same procedure as above. The LiMn_{1.7}Al_{0.3}O₄ powders were prepared using 1.10 g LiNO₃, 6.80 g Mn(NO₃)₂.4H₂O, 1.80 g Al(NO₃)₂.9H₂O and 2.87 g Urea. The powders were similarly named LMOA-A, LMAO-AM and LMOA-MA. The powders were ground between annealing and microwave irradiation steps. The schematic of the procedure is shown in FIG. 1.

### Materials Characterization

The prepared powders were studied using a LEO 1525 field emission scanning microscope (FE-SEM) with the acceleration voltage of 2.00 kV. Each sample was prepared by putting approximately 0.1 mg of the sample on a carbon tape and then coated to prevent charging. HRTEM measurements were carried out on a Joel HRJEM-2100 microscopy unit using a LAB6 filament as an electron source. The measurements were carried out using an electron beam at 200 kV. About 2 mg of a sample was dissolved in ethanol. The mixture was then sonicated for 10 min to homogeneously disperse the sample in the solvent. A drop of the sample solution was then spread on a carbon copper grid (200 mesh) and allowed to dry at room temperature. The grid was then mounted onto the TEM chamber for the analysis. For X-ray diffraction (XRD) analysis, the sample powders were analysed using an X-ray diffraction spectrometer using a PANalytical X'Pert Pro diffractometer with CuKα radiation, with a wavelength of λ=1.5046 A as a radiation source operating at 45 kV and 40 mA. The XRD diffractograms were obtained in a scan range between 0 and 90°. XPS measurements were carried out using a Kratos Axis Ultra-DLD system (Shimadzu) with Al Kα radiation (1486.6 eV). The binding energy was calibrated with reference to the C 1s level of the carbon (284.6 eV). The FTIR spectra were recorded using a Perkin Elmer Spectrum 100 FTIR spectrometer in the range 400-4000. The analysis was carried out using a diamond crystal probe and air was used as a background. Pellets of the samples were mixed with KBr in the ratio 1:3 and prepared by a disk method. The pellets were made using a thickness that provided good transparency for IR radiation. Raman measurements were carried out in air using a Horiba Jobin Yvon spectrometer equipped with 10× objective lens to focus the laser beam on a small selected area of the sample, a 30 mW green argon laser (514 nm wavelength) an excitation source, and a 1800 lines/mm grating monochromator with an air-cooled CCD detector. The sample was mounted on the stage of a confocal microscope, and visualized, by means of a camera, on a monitor. The laser was focused through a confocal microscope onto the sample. The scattered radiation was collected back through lenses and transmitted by through a series of optics and then focused onto the entrance slit of a grid monochromator. Raman spectra were measured up to 1000 cm⁻¹ on the stokes side, with a spectral resolution of about 3 cm⁻¹. The spectra (intensity of the scattered radiation versus wave number) were processed by a computer. The measurements were taken at room temperature.

### Fabrication of Lithium Ion Battery Coin Cells

The cathodes for the electrochemical studies were prepared by making up of a slurry which contained 80% of the prepared electroactive LMO powder mixed with 10% carbon black and 10% polyvinylidene fluoride (PVDF) binder in N-methyl-2-pyrrolidone (NMP) as the solvent. The slurry was applied using a doctor-blade method onto an aluminum foil as a current collector. The coated aluminum foil was dried under vacuum at 110° C. for 12 h. The coated cathode foil was then pressed to form a uniform layer and circular disk electrodes were punched from the coated aluminum foil. The electrodes were again heated in the vacuum oven to decompose materials that might have adsorbed on the electrodes and evaporate water adhered on the electrode surface. The vacuum was used in order to avoid damaging the electrodes by using high temperature, because the vacuum environment inside the oven lowers the boiling temperature of water. The electrodes were heated at 80° C. for at least 6 h. The electrodes were then put in a glove box for 2 h before the fabrication of the coin cells so as to have them in the same environment as the glove box when the coin cells are fabricated.

The electrochemical measurements were performed using a coin type cell (CR 2032). The coin cells (not shown) each comprised the cathode made from the prepared LMO powders, lithium metal as the anode and non-aqueous electrolyte. The coin cells also each contained a spacer which was made from stainless steel to provide an electrical connection from the electrode to the cell case or housing and a spring to exert pressure on the components to allow maximum contact of the cathode and anode when the coin cell is sealed. Enough electrolyte was put on the separator, between the cathode and the anode.

The coin cells were assembled in a glove box filled with ultra-high purity argon gas. The concentration of H₂O and O₂ was maintained at <0.5 ppm because lithium is highly reactive and reacts rapidly with water. The electrolyte is also affected by water; water can cause the electrolyte to be acidic which then will dissolve the cathode materials and can cause a failure in the coin cells. A 1 M LiPF₆ in EC/DEC/DMC in 1:1:1 volume ratio solution was prepared and used as the electrolyte. LiF₆P (7.5945 g) was dissolved in mixture of EC (20 ml), DEC (20 ml) and DMC (20 ml) solvents. The resulted solution was shaken to completely dissolve the salt. The electrolyte was prepared in the glove box (MBRAUN MB10 compact) because the moisture in the lab environment would cause the electrolyte to be acidic. The electrolyte was left in the glove box overnight before being used to fabricate the coin cells. A Celgard polypropylene-based membrane was used as the separator. After all components of the coin cells were aligned, the coin cell was sealed with a Compact Hydraulic Crimping Machine (MSK-110). The pressure of the crimper is important as it also contributes to the working of the coin cell. The pressure on the crimper was set at 750 psi to seal the coin cells. After fabrication, the open circuit voltage was measured and the coin cells were allowed to stand for 24 h before the electrochemical measurements were performed. This allowed the electrolyte to wet the electrodes thoroughly and allowed the coin cells to stabilize.

### Electrochemical Characterization of Coin Cells

Cyclic voltammetry (CV) was conducted using the coin cell wherein the prepared LMO cathode samples were used as the working electrode and lithium metal was used as the counter and reference electrodes. The scans were performed at the rate of 0.1 mVs⁻¹ over a range of 3.5 V-4.3 V using a Bio-Logic science VMP3-based instrument. The EIS measurements were performed in the range from 100 kHz to 1 mHz with an AC signal amplitude of 10 mV. The Data acquisition and analysis were performed with the Bio-Logic science VMP3-based instrument using the EC-lab V10.32 software. The charge-discharge capacity and cycle performance (rate capability) were measured at different C-rates (charge-discharge rates) between 3.5-4.3 V using a Maccor 4000 battery tester. All of the electrochemical performance measurements were carried at room temperature.

### Results and Discussion

### FESEM Characterisation

The SEM images of the LMO and Al-doped LMO at low and high magnifications are shown in FIGS. 2 and 3, respectively. For the LMO, the images depict spherical-like secondary particles formed by the aggregation of octahedral primary particles. All of the prepared samples have octahedral-shaped primary particles, meaning that the microwave irradiation did not change the shape of the particles. The average sizes for primary particles (crystallites) and secondary particles are 132 nm and 5.20 μm for the LMO-A; 196 nm and 6 μm for LMO-AM; and 133 nm and 3.37 μm for the LMO-MA. The LMO-AM shows a narrow particle size distribution which suggests that microwave irradiation after the annealing step favoured the growth kinetics in the powders and thus increased the particle size. Unlike the LMO-A, the LMO-MA gave a narrow size distribution with small-sized particles, indicating that microwave irradiation at the pre-annealing step leads to near-completion of crystallization process of the spinel thus making further particle growth via high temperature annealing slow compared to the bare sample (LMO-A). The commercial sample (LMO-comm) is generally micron-sized suggesting that the preparation method must have involved long annealing period which usually result in crystal growth.

From the SEM images of the Al-doped LMO samples (FIG. 3), the samples are generally nano-sized particles compared to the undoped LMO samples (FIG. 2). This is not surprising if one considers that surface areas of doped samples are usually higher than un-doped samples [15]. The uniformity and agglomeration of particles are larger for LMOA-AM and LMOA-MA compared to the LMOA-A samples. The particle size distributions vary, but within the ≤50 nm particle size population range, the LMOA-A dominates; i.e., LMOA-A (˜62%)>LMOA-AM (˜36%)>(LMOA-MA (˜24%). It is interesting to observe that the LMOA-A contains small amounts of large-sized particles (120-130 nm), but upon microwave irradiation, the maximum particle size was 80 nm, which is an indication that microwave irradiation is able to shrink the particles for enhanced crystallinity and electrochemical performance as shown hereinafter.

### HRTEM Characterisation

The TEM images of LMO powders and their Al-doped counterparts are shown in FIGS. 4 and 5, respectively. The LMO-AM consists of relatively big particles when compared to LMO-A and LMO-MA. The LMO powders gave large particle sizes compared to their LMOA counterparts, which is in agreement with the SEM results. The HRTEM micrographs prove that the powders are crystalline as the lattice spacing can be clearly observed. The average d-spacings were calculated to be 0.57, 0.49, 0.42 nm for LMO-A, LMO-AM and LMO-MA, respectively. For the Al-doped LMO, the average d-spacings were 0.61, 055, 0.56 nm for LMOA-A, LMOA-AM and LMOA-MA, respectively. The d-spacing values clearly confirm the (111) plane in the lattice structure. The slightly higher values of d-spacing for the Al-doped LMO indicate the successful introduction of the foreign Al into the spinel structure.

### XRD Characterisation

The XRD patterns for the LMO and Al-doped LMO powders are shown in FIG. 6. The diffraction peaks are well-developed confirming that pure spinel LiMn₂O₄ and LiAl_{0.3}Mn_{1.7}O₄ materials. The peaks were indexed to the characteristic diffractions of spinel LiMn₂O₄ (JCPDS File No. 88-1749) with space group Fd-3m space, corresponding to the (111), (311), (222), (400), (331), (551), (440), and (531) planes. The XRD patterns for all the powders are similar but the relative intensities for LMO-MA are much stronger than for LMO-A and LMO-AM, meaning that LMO-MA is more crystalline than the LMO-A and LMO-AM. The high degree of crystallinity for the spinel LMO materials is important for the electrochemical properties of the spinels.

Table 1 summarises the values of the lattice parameters of the spinel powders. Table 1 provides some interesting information. First, the LMO-A shows the largest lattice parameters, which decreased upon microwave irradiation and/or doping with aluminium. The lattice contraction means a decrease in the Mn³⁺ and increase in the Mn⁴⁺ ion (since the radius of Mn³⁺ (0.66 Å) is greater than that of Mn⁴⁺ (0.60 Å)[30]. Second, there is a dramatic contraction of the lattice parameters for the Al-doped samples which is due to the fact that the radius of Mn³⁺ (0.66 Å) is greater than Al³⁺ (0.53 Å), and the bond length of Mn—O (1.90 Å) is longer than Al—O (1.62 Å), when Al³⁺ substitutes Mn³⁺ in the 16d site of spinel structure, it will result in the shrinking of the unit cell. In general, the lattice contraction increases the spinel structural stability of the spinel, which is beneficial to the suppression of Jahn-Teller distortion. The smaller the intensity ratio of the (311)/(400) peaks, the more crystalline the material, thus, the two microwaved samples (LMO-MA and LMOA-AM) with the lowest values are more crystalline than the other samples.

TABLE 1
Comparative values of lattice parameters of LMO and LMOA powders

| | Lattice | Unit cell | | |
|---|---|---|---|---|
| Material | parameter (Å) | volume (Å³) | I₃₁₁/I₄₀₀ | ref |
| LMO-A | 8.2565 | 562.84 | 0.991 | This work |
| LMO-AM | 8.2441 | 560.31 | 1.043 | This work |
| LMO-MA | 8.2403 | 559.54 | 0.944 | This work |
| LMO-Comm | 8.2161 | 554.62 | 1.012 | This work |
| LMO | 8.2404 | 559.56 | 1.108 | [1] |
| LMOA-A | 8.1701 | 545.36 | 0.991 | This work |
| LMOA-AM | 8.1671 | 544.76 | 0.953 | This work |
| LMOA-MA | 8.1696 | 545.26 | 0.996 | This work |

### XPS Characterisation

To determine the actual amounts of the Mn³⁺ and Mn⁴⁺ in the spinel, XPS experiments were performed for the powdered spinel samples. The Mn 2p_{3/2} XPS spectra of the materials studied are shown in FIG. 7. The broad Mn 2p_{3/2} peaks were deconvoluted into two peaks to obtain the two different oxidation states of the Mn ion. The ratios of Mn³⁺ to Me including the average manganese valence states (n_{Mn}) are shown in Table 2, corroborating the lattice contraction observed in the XRD analysis. As will be shown later, the LMO materials with n_{Mn}≈3.5+ were able to retain their capacity upon continuous charge-discharge cycling. It is interesting to note that both the LMO prepared without any microwave irradiation (LMO-A) and the commercial LMO material (LMO-comm) gave n_{Mn} values of 3.165+ and 3.400+, respectively, clearly contracting the general notion that LMO powders should be n_{Mn}≈3.5+. More interesting is that when the LMO-A was subjected to MWI to obtain the LMO-AM, a lattice shrinkage (from 8.256 to 8.244 Å) was observed leading to n_{Mn}≈3.5+. This result suggests that the MWI in this case plays the role of an oxidant (i.e., converting the excess Mn³⁺ to Mn⁴⁺).

TABLE 2
Mn 2p_{3/2} peak positions and Mn³⁺/Mn⁴⁺ cation distribution

| | Binding energy | | Cation distribution | | | Average Mn |
|---|---|---|---|---|---|---|
| | position (eV) | | Mn⁴⁺/ | Mn³⁺/ | Mn³⁺/ | valence |
| Sample | Mn⁴⁺ | Mn³⁺ | % | % | Mn⁴⁺ | (n_{Mn}) |
| LMO-A | 644.5 | 642.2 | 16.5 | 83.5 | 5.06 | 3.165 |
| LMO-AM | 645.8 | 642.7 | 49.7 | 50.3 | 1.01 | 3.498 |
| LMO-MA | 646.5 | 644.6 | 54.2 | 45.8 | 0.85 | 3.541 |
| LMO-Comm | 644.1 | 642.6 | 40.1 | 59.9 | 1.50 | 3.400 |
| LMO[1] | — | — | 51 | 49 | 0.96 | 3.503 |
| LMOA-A | 642.4 | 644.4 | 31.0 | 69.0 | 2.23 | 3.310 |
| LMOA-AM | 642.7 | 644.4 | 49.2 | 50.8 | 1.03 | 3.493 |
| LMOA-MA | 642.6 | 644.3 | 68.8 | 31.2 | 0.45 | 3.690 |

### Raman Spectroscopic Characterisation

Raman spectroscopy was used to investigate the impact of the synthesis methods for the Jahn-Teller distortion by analysing directly the near-neighbour environment of oxygen coordination around manganese cations. The Raman spectra of the LMO and its Al-doped counterparts are shown in FIG. 8. The Raman spectra are consistent with literature as LiMn₂O₄ usually show a strong peak around 625 cm⁻¹ and a broad, less-defined shoulder between 550 and 600 cm⁻¹, with some poorly defined structures below 500 cm⁻¹ [32]. The spectral features in the frequency region below 500 cm⁻¹ (i.e., between 350 and 400 cm⁻¹) belong to the LiO₄ tetrahedra and between 450 and 650 cm⁻¹ frequency region the features belong to the vibrational modes of the MnO₆ octahedra. The peak around the 600-650 cm⁻¹ are due to the symmetric Mn—O stretching vibration of the MnO₆ groups, assigned to the A_{1g} species in the Oₕ⁷ spectroscopic space group [3]. The broadening of these peaks can be attributed to the cation-anion bond lengths and polyhedral distortion occurring in LMO (i.e., the stretching vibrations of Mn³⁺O₆ and Mn⁴⁺O₆ octahedra). For the Al-doped LMO, the characteristic Raman peak of Mn—O vibration for the samples was observed at ca. 637, 642 and 632 cm⁻¹ for LMOA-A, LMOA-AM and LMOA-MA, respectively. The shifting of the peak compared to the undoped LMO is due to the existence of Al³⁺ ions in some of the octahedral sites. Me has a large spin orbital constant of ca. 138 cm⁻¹ compared to Mn³⁺ with spin orbital splitting of ca. 90 cm⁻¹, thus the bond strength of Mn⁴⁺—O increases after doping with Al³⁺ ions and thus result in the peak shifts.

### FTIR Characterisation

FTIR can be used to study the effects of microwaves on the M-O and M-M bonds in the prepared samples, where M is lithium or manganese metal. FIG. 9 shows the FTIR spectra for the LMO and the Al-doped LMO. The spectra of the LMO samples are dominated by two intense absorption bands in the finger print region. These bands appear at ca. 613/515, 616/514 and 612/507 cm⁻¹ for LMO-A, LMO-AM and LMO-MA respectively. For the Al-doped LMO, these peaks appear at 635/523, 632/523, and 635/522 cm⁻¹ for LMOA-A, LMOA-AM and LMOA-MA, respectively. It is known from the literature that the FTIR spectra for LiMn₂O₄ are characterised by two strong absorption bands at ca. 615 and 513 cm⁻¹ [3], thus the results achieved are consistent with literature. These two IR-dominating bands are ascribed to the F₁ᵤ species, with the high frequency bands relating to the asymmetric stretching modes of MnO₆ group [3]. These FTIR peaks are slightly shifted from the peaks observed at 615 and 513 cm⁻¹ for the un-doped-LMO. This is due to the relatively stronger bonding in the Mn(Al)O₆ octahedra due to Al doping and the microwaves. The Al—O bond (512 kJ mol⁻¹) is stronger than the Mn—O bond (402 kJ mol⁻¹) in the octahedron. The Al-doping and microwave irradiation increase the stability of the spinel structure by decreasing the average Mn—O bond and increases the average oxidation state of Mn ion.

### Electrochemical Studies of LMO Powders

### Cyclic Voltammetry

The cyclic voltammetric evolutions of the lithium ion battery coin cells fabricated from the various LMO and Al-doped LMO at slow scan rate of 0.1 mVs⁻¹ are shown in FIG. 10. Each of the materials exhibits two redox couples (1/1′ and 2/2′), with the LMO-MA showing a low intensity cathodic peak appearing as a shoulder peak below 3.874 V (peak 3), which can be attributed to the ‘formation cycle’ during initial cycles whereby minor structural rearrangement of the lattice takes occur [4]. The existence of the two redox couples for the complexes (LiAlₓMn₂₋ₓO₄, where x=0 and 0.3 for the LMO and LMOA, respectively) indicates that the insertion or extraction of lithium ion proceeds in two steps, according to reactions (2) and (3) [5].

LiAlₓMn₂₋ₓO₄→Li_{0.5}AlₓMn₂₋ₓO₄+0.5Li⁺+0.5e⁻ (2)

Li_{0.5}AlₓMn₂₋ₓO₄→2λ-MnO₂+0.5Li⁺+0.5e⁻ (3)

where Li_{0.5}AlₓMn₂₋ₓO₄ is more stable than LiAlₓMn₂₋ₓO₄. More clearly, the first anodic peak is due to the removal of Li from half of the tetrahedral (8a) sites in which Li—Li interactions take place. The second anodic peak is due to the removal of Li-ions from the remaining tetrahedral sites, where no Li—Li interactions occur; i.e. where lithium de-intercalation leading to λ-MnO₂ occurs [6].

To provide an insight into the kinetics and reversibility of the redox processes, the CVs were analysed in terms of the ratio of the anodic to cathodic peak current (Iₚₐ/I_{pc}), peak-to-peak separations of the anodic and peak potentials (ΔEₚ), and half-wave potential or the mid-points between the charge and discharge potentials (ΔE_{1/2}), and summarised in Table 3. For a reversible process, the Iₚₐ/I_{pc} should be approximately unity, and the ΔEₚ (i.e., difference between anodic and cathodic peak potentials, |Eₚₐ|−|E_{pc}|) should ideally be about 0.060 V. From the Table 3, it is evident that, within the limits of experimental errors, the redox couples are reversible with same (ΔE_{1/2}). In theory, the open-circuit voltage (OCV) is equivalent to the (ΔE_{1/2}).

TABLE 3
Cyclic voltammetric data for the redox couples
shown by the LMO and Al-doped LMO materials.

| | Iₚₐ/I_{pc} | | ΔEₚ (V) | | ΔE_{1/2} (V) | |
|---|---|---|---|---|---|---|
| | Redox | Redox | Redox | Redox | Redox | Redox |
| | couple | couple | couple | couple | couple | couple |
| Material | 1/1′ | 2/2′ | 1/1′ | 2/2′ | 1/1′ | 2/2′ |
| LMO-A | 1.06 | 1.22 | 0.16 | 0.12 | 4.00 | 4.13 |
| LMO-AM | 1.17 | 1.14 | 0.09 | 0.07 | 4.01 | 4.13 |
| LMO-MA | 1.18 | 1.09 | 0.08 | 0.07 | 4.01 | 4.13 |
| LMOA-A | 1.07 | 1.50 | 0.10 | 0.13 | 4.00 | 4.14 |
| LMOA-AM | 1.12 | 1.25 | 0.11 | 0.08 | 4.05 | 4.15 |
| LMOA-MA | 1.05 | 1.23 | 0.10 | 0.09 | 4.05 | 4.15 |

### Galvanostatic Charge-Discharge

FIG. 11 shows typical galvanostatic charge-discharge curves obtained at room temperature for the prepared LMO and its Al-doped counterparts. The coin cells were cycled at a constant current of 14 mA g⁻¹ (current rate of 0.1 C, assuming 1 C=140 mAg⁻¹), in the voltage range of 3.5 to 4.3 V vs. Li/Li⁺.

For the LMO-based coin cells (FIG. 11a), we observed two distinct potential plateaus at ca. 4.12 V and 4.00 V in both charge and discharge curve due to the two step lithium intercalation behaviour as observed in CV results. The plateau at 4.00 V was observed in the CV results correspond to reaction (2) and at 4.12 V corresponds to reaction (3). These plateaus are longer for LMO-MA and shorter for LMO-AM curves as can be seen in the FIG. 11a, suggesting that there are more lithium ions extracted in LMO-MA cathode materials as the cell is cycled than in the other cathode materials. These peaks are in good agreement with literature for single phase spinel LMO structure. Unlike the LMO species, the Al-doped LMO (FIG. 11b) did not show the two potential plateaus but rather only a simple potential decay was observed. This is in excellent agreement with the work of Myung et al [7] on LiAl_{0.3}Mn_{1.7}O₄ which attributed the monotonous potential change to a possible single-phase reaction in the potential range. Note that the discharge capacities for the Al-doped LMO samples are lower than that of un-doped LMO sample, and this is because of the replacement of the redox-active Mn³⁺ with redox-inactive Al³⁺ in the spinel structure.

### Capacity Retention and Coulombic Efficiency

An important feature of this invention is capacity retention or the ability of the cathode materials to reduce or completely eliminate capacity fading upon continuous cycling. The comparative plots of the discharge capacity against cycle number curves are shown in FIG. 12. The LMO-A (n_{Mn}=3.165+) with an initial discharge capacity of 127 mAhg⁻¹ retained only 78% of it after 50 cycles. LMO-AM (n_{Mn}=3.498+) with initial discharge capacity 94 mAhg⁻¹ retained 91% of it after 50 cycles. LMO-MA (n_{Mn}=3.541+) with a high initial discharge capacity of 131 mAhg⁻¹ retained 95% of its initial capacity after 50 cycles, and LMO-comm (n_{Mn}=3.400) with initial discharge capacity of 105 mAhg⁻¹ retained 90% its capacity after 50 cycles. All the Al-doped LMO showed lower discharge capacity but, interestingly, retained approximately 100% of their initial capacity after 50 cycles. From these results, it is evident that (i) the LMO and Al-doped LMO materials with n_{Mn}≈3.5+(i.e., LMO-AM, LMO-MA and LMOA-AM) give the highest capacity and best capacity retention, (ii) the best performing LMO and Al-doped LMO (i.e., n_{Mn}≈3.5+) can be obtained by a pre- or post-annealing microwave irradiation step. The discharge capacity of the LMOA material decreased as follows: LMOA-AM (107 mAhg⁻¹, n_{Mn}=3.493+)>LMOA-A (95 mAhg⁻¹, n_{Mn}=3.310+)>LMOA-MA (75 mAhg⁻¹, n_{Mn}=3.690+). Thus, it may be concluded that the best-performing LMO and LMOA (high capacity and capacity retention) is one with an n_{Mn} 3.5+. The LMOA-A with lower oxidation state of 3.31+ for Mn gave better capacity retention than LMO-AM, LMO-MA and LMOA-MA with higher n_{Mn} values of ca. 3.5+, 3.54+ and 3.69+. These results are in agreement with those of Shin and Manthiram [8] which showed that LiMn_{1.9}Ti_{0.1}O₄ with a lower n_{Mn} value of 3.47+ exhibited better capacity retention than LiMn_{1.9}Al_{0.1}O₄, LiMn_{1.9}Al_{0.05}Ti₀₀₅O₄, and LiMn_{1.85}Ti_{0.075}Li_{0.075}O₄ with a higher n_{Mn} value of >3.5+. The difference means that factors other than increased n_{Mn} value could be playing a role in capacity retention. However, the results of this Example contradict reports of other workers whose data predict that higher capacity retention can only be obtained at n_{Mn}>3.50+[9, 10]. For example, recently Raguparthy [11] reported dual-doped LMO (with Zn and Ti as dopants) gave the best performance with n_{Mn}>3.6+. Shin and Manthiram (JECS 2004) [9] reported best performance at n_{Mn}>3.58+. Also, Zhang et al [1] obtained LMO and dual-doped LMO (doping with Ni and Mg) using microwave irradiation as the heating source for annealing steps, and reported that the best performing dual-doped LMO was with n_{Mn}=3.571+. Although their materials were obtained at a short synthesis period, it is interesting to note that the obtained LMO (with average particle size of 0.5-1 μm) with n_{Mn}=3.503+ exhibited poor capacity retention, suggesting that microwave irradiation can e used beyond merely achieving faster preparation but can rather be utilised for improving the electrochemistry of LMO. In general, LMO and doped-LMO with n_{Mn}≈3.5+ with no Jahn-Teller effect can be obtained if microwave irradiation is strategically used in the synthesis step. In fact, the elimination of Jahn-Teller effect is not just a factor of n_{Mn}>3.5+ alone but other factors such as the nature of the particle, lattice parameter, and strategic microwave irradiation.

Coloumbic efficiency (CE) is a measure the amount of parasitic reactions (such as water electrolysis and other side redox reactions) that take place within cell during cycling, and it is defined as (4) [12]:

$$C E ( \% ) = \frac{{Q}_{out}}{{Q}_{i n}} \times 100 \% \qquad ( 4 )$$

where Qₒᵤₜ is the amount of charge that leaves the battery during the discharge cycle and Qᵢₙ the amount of charge that enters the battery during the charging cycle. Parasitic reactions lead to capacity loss and negatively affect the life time of the batteries. From FIG. 12, the coulombic efficiency after 50 cycles follows this trend: LMO-MA (˜99%)>LMO-A (98.5%)>LMO-AM (98.1%)>LMO-comm (90.2%), meaning that LMO-MA cells show the best CE indicating excellent cycling stability, reversibility and increased cycle life. The Al-doped LMO also gave excellent coulombic efficiency; LMOA-A (99.3%)>LMOA-AM (98.5%)≈LMO-A (98.5%)>LMOA-MA (98%).

TABLE 4
Summary of electrochemical data vs crystal chemical data of the
LMO and Al-doped LMO materials

| | Initial | Capacity loss of initial | Lattice | |
|---|---|---|---|---|
| | capacity | capacity after 50 | parameter | Mn |
| Material | (mAhg⁻¹) | cycles (%) | (Å) | valence |
| LMO-A | 127.5 | 22.0 | 8.2565 | 3.165 |
| LMO-AM | 94.3 | 9.0 | 8.2441 | 3.498 |
| LMO-MA | 131.5 | 5.0 | 8.2403 | 3.541 |
| LMO[8] | 118.6 | 66.8 | 8.2489 | 3.50 |
| LMOA-A | 95.3 | 0.4 | 8.1701 | 3.310 |
| LMOA-AM | 103.6 | 0.7 | 8.1671 | 3.493 |
| LMOA-MA | 73.6 | 1.0 | 8.1696 | 3.690 |

### Rate Capability

The rate capability of the powders was evaluated at different C-rates, 0.1, 0.5, 1 and 2 C (assuming 1 C=140 mA g⁻¹). FIG. 13 shows the rate performance of the LMO powders. The C-rate was increased every five cycles. The capacity decreased as the C-rate was increased since at higher C-rates the Li ions are removed rapidly during charging (de-intercalation) and there is not enough time for all of them to return to the cathode during discharging (intercalation). The decrease in plateau as the C-rate increases is normally large for spinel LMO systems due distortion of the structure arising from the Jahn-Teller distortion. As seen from the FIG. 13, the decrease at high C-rate was greatly improved for LMO-MA and LMO-AM samples as the difference between the initial capacities for the different c-rates is small. Thus, the coin cells showed good cycle stability for the microwaved samples, LMO-AM and LMO-MA.

### Electrochemical Impedance Spectroscopic Analysis

Electrochemical impedance spectroscopy (EIS) is an important technique for investigating the kinetics of lithium ion intercalation/de-intercalation and to determine the lithium ion diffusion coefficient. The impedance spectra were measured at the theoretical OCV ΔE_{1/2} as determined from the CV measurements (ca. 4.0 V). Each spectrum was obtained at room temperature and the cells were equilibrated for 1 h at each voltage. FIG. 14 compares the experimental and fitted Nyquist plots of the LMO and Al-doped LMO. The experimental data were satisfactorily fitted with an equivalent circuit shown FIG. 14(d). The fitting parameters involves the solution ohmic resistance of the electrode system (Rₛ) due to electric conductivity of the electrolyte, separator and electrodes; the surface film resistance (R_{f}) and constant phase element (CPE_{f}), referring to the resistance and capacitance due to the solid-electrolyte interface layer formed on the electrode surface; the charge transfer resistance (R_{ct}) and interfacial capacitance (CPE_{Li}), corresponding to lithium intercalation/de-intercalation process arises at the interface between the electrode and the electrolyte, and the Warburg element (Z_{w}) describing the solid state diffusion of lithium ion between the particles of active materials and electrolyte, signified by the straight sloping line (˜45°) at the low frequency region.

The impedance spectra for all the compounds consist of one clear semicircle in the frequency region 1 MHz-10 Hz and a straight line with an inclined slope in the low frequency region. The semicircle seen in this frequency region is actually an overlap of semicircles in high and medium frequencies. Generally, as also evident from the equivalent circuit, a semicircle in the high frequency region is due to the surface film resistance (R_{f}), semicircle in the middle frequency region is due to the lithium charge transfer resistance (R_{Li}) and interfacial capacitance (CPE_{Li}). The most significant parameters (Rₛ, R_{f}, and R_{Li}) are summarised in Table 5. From Table 5, the lithium ion conductivity (R_{Li}) decreases as LMO-MA>LMO-A>LMOA-MA. This trend clearly suggests that the lithium ion conductivity is controlled by a combination of particle size and Mn³⁺ concentration, the smaller the particle size and the higher the Mn³⁺ concentration, the greater is the lithium ion conductivity. The same phenomenon applies to the Al-doped LMO materials (i.e., LMOA-A>LMOA-AM>LMOA-MA). The LMOA-A gave smaller R_{Li} (˜11) and larger R_{f} (˜82) compared to its LMO-A counterpart which are 19.64 and 13.7, respectively. This is agreement with literature (ECA and its ref [12]), and should be expected considering that aluminium is redox-silent and R_{f} is related to the conductivity of the SEI film (p) according to the following relationship (5);

$${R}_{f} = \frac{ρ l}{A} \qquad ( 5 )$$

where l is the film thickness and A the surface area of the electrode. Surprisingly, however, the microwaved samples of Al-doped LMO showed poor kinetics compared to their LMO counterparts, which seem to indicate that the microwave must have induced migration of the aluminium species to the surface of the LMO leading to poor conductivity. More research is necessary to further explore this phenomenon.

TABLE 5
Electrochemical Impedance parameters for coin cells obtained from
the LMO and Al-doped LMO powders at 4.0 V

| LMO and LMOA | Electrochemical Impedance parameters | | |
|---|---|---|---|
| based coin cells | Rₛ (Ω) | R_{f} (Ω) | R_{Li} (Ω) |
| LMO-A | 3.1 | 13.7 | 19.64 |
| LMOA-A | 4.873 | 82.07 | 11.17 |
| LMO-AM | 4.2 | 4.6 | 26.5 |
| LMOA-AM | 4.793 | 17.21 | 97.71 |
| LMO-MA | 2.5 | 141.1 | 15.0 |
| LMOA-MA | 16.54 | 976.4 | 33.29 |

The lithium diffusion coefficient of lithium ions was calculated using the Warburg parameter obtained from the EIS results, using equation (6) [13];

$${D}_{Li} = \frac{2 {R}^{2} {T}^{2}}{{n}^{4} {F}^{4} {σ}^{2} {A}^{2} {Cli}^{2}} \qquad ( 6 )$$

where D_{Li} is the lithium ion diffusion coefficient, R is the gas constant, T is the absolute temperature, n is the number of electrons transferred, F is the Faraday constant, σ is the Warburg parameter (obtained from the slope of a plot of real impedance (Z′) vs reciprocal square root of frequency (ω^{-1/2}) in the low frequency region, not shown), A is the geometric surface area of the cathode and C_{Li} is the concentration of lithium in the cathode material. The values of calculated diffusion coefficients are summarised in Table 6. The values compare well with those reported in literature. In general, LMOs allow for faster diffusion than LMOAs, due to the replacement of the conductive Mn³⁺ with redox-inactive Al³⁺.

TABLE 6
Calculated diffusion coefficients for lithium ions for LMO and LMOA-
based coin cells obtained at 4.0 V.

| LMO and LMOA based coin cells | 10⁹ D_{Li}/cm²s⁻¹ |
|---|---|
| LMO-A | 30.43 |
| LMO-AM | 56.82 |
| LMO-MA | 68.99 |
| LMOA-A | 3.25 |
| LMOA-AM | 39.75 |
| LMOA-MA | 3.04 |

Until now, the average valence (n_{Mn}) of manganese has been known to be the determining factor for capacity retention in LiMn₂O₄ spinel cathode material for rechargeable lithium ion battery; when the concentration of Mn³⁺ ions exceeds that of Mn⁴⁺ ions (n_{Mn}<3.5+) capacity fade/loss becomes prominent, but when n_{Mn}>3.5+ capacity retention is improved. This Example, for the first time, the application of microwave irradiation at the pre- and post-annealing steps of the synthesis of LiAlₓMn₂₋ₓO₄ (x=0 and 0.3) spinel cathode materials for rechargeable lithium ion battery with the view to understanding and optimizing the manganese redox states or valence number for enhanced capacity retention. The Example showed that strategic microwave irradiation can be used to shrink the spinel particles and lattice parameters for improved crystallinity, and tune the Mn³⁺/Mn⁴⁺ ratio, and that the LMO spinel materials with n_{Mn}≈3.5+ gave the best electrochemical performance. The reaction kinetics and lithium ion diffusivity were greatly improved for the LMO-based cells than at the LMOA-based cells, which was associated with the replacement of the conductive Mn³⁺ with redox-silent Al³⁺. Until now, microwave irradiation has only been used as a mere heat source to sinter materials and make reactions go faster. Thus, the findings in this Example can potentially revolutionize how microwave irradiation is used in the preparation of LMO spinel materials.

Thus, in this Example, microwave irradiation at the pre- and post-annealing steps of the synthesis of LiAlₓMn₂₋ₓO₄ (x=0 and 0.3) spinel cathode materials for rechargeable lithium ion battery was investigated with a view to understanding and optimising the manganese redox states or valence number (n_{Mn}) for enhanced capacity and capacity retention. The average valence of manganese has long been known as the major determining factor for capacity fade in LiMn₂O₄; when the concentration of Mn³⁺ ions exceeds that of Mn⁴⁺ ions (n_{Mn}<3.5+) the Jahn-Teller effect (capacity fade) becomes prominent, and vice versa. The strategic microwave-assisted synthesis of LiMn₂O₄ (LMO) and LiAl_{0.3}Mn_{1.7}O₄ (LMOA) strongly correlate to the lattice parameter, initial manganese valence, particle size and morphology, reversibility of the de-intercalation/intercalation processes, capacity loss upon continuous cycling, and lithium diffusivity. The SEM, TEM and XRD results proved that microwave irradiation is able to shrink the particles for improved crystallinity. The XPS data clearly suggest that microwave can be used to tune the Mn³⁺/Mn⁴⁺ ratio, and that the LMO spinel materials with n_{Mn}≈3.5+ gave the best electrochemical performance. The capacity retention of aluminium-doped LMO spinel with n_{Mn}<3.5+ is as good as those with n_{Mn}≥3.5+, suggesting that other factors other than increased n_{Mn} values could play a role in the suppression of capacity fading. The microwave-irradiated LMO and LMOA spinels gave enhanced reversibility of the de-intercalation/intercalation processes, especially that involving the λ-MnO₂ species. The reaction kinetics and lithium ion diffusivity was much faster at the LMO-based cells than at the LMOA-based cells, which was interpreted to be related to the replacement of the conductive Mn³⁺ with redox-silent Al³⁺.

Accordingly, in this Example, a microwave-assisted solution combustion synthesis method was used to synthesise LMO and Al-doped LMO. It was clearly shown how strategic application of MWI at either the pre-heating or post-annealing steps of the synthesis can be employed to enhance cycling behaviour by controlling the manganese valence state, structure, and morphological integrity of the LMO and Al-doped LMO. In a nutshell, the MWI can be used as a viable ‘curative’ treatment to LMO and powder to enhance its capacity retention upon continuous cycling. The solution combustion synthesis method is industrially attractive due to its low cost, simplicity and fastness with the resultant powder products exhibiting perfect spinel structures with uniform size distribution of particles.

### REFERENCES

[1] H. Zhang, Y. Xu, D. Liu, X. Zhang, C. Zhao, Electrochimica Acta, 125 (2014), 225-231.
[2] A. Paolone, A. Sacchetti, T. Corridoni, P. Postorino, R. Cantelli, G. Rousse, et al., Solid State Ionics, 170 (2004) 135-138.
[3] C. M. Julien, M. Massot, Materials Science and Engineering: B, 97 (2003) 217-230.
[4] X. Zhao, M. Reddy, H. Liu, S. Ramakrishna, G. S. Rao, B. Chowdari, RSC Advances, 2 (2012) 7462-7469.
[5] M. Reddy, A. Sakunthala, S. SelvashekaraPandian, B. Chowdari, The Journal of Physical Chemistry C, 117 (2013) 9056-9064.
[6] X. M. Wu, X. H. Li, Z. B. Xiao, J. Liu, W. B. Yan, M. Y. Ma, Materials Chemistry and Physics, 84 (2004) 182-186.
[7] S. Myung, S. Komaba, N. Kumagai, Journal of the Electrochemical Society, 148 (2001) A482-A489.
[8] Y. Shin, A. Manthiram, Chemistry of materials, 15 (2003) 2954-2961.
[9] Y. Shin, A. Manthiram, Journal of the Electrochemical Society, 151 (2004) A204-A208.
[10] R. J. Gummow, A. de Kock, M. M. Thackeray, Solid State Ionics, 69 (1994) 59-67.
[11] P. Ragupathy, RSC Advances, 4 (2014) 670-675.
[12] A. Smith, J. Burns, J. Dahn, Electrochemical and Solid-State Letters, 13 (2010) A177-A179.
[13] C. J. Jafta, K. I. Ozoemena, M. K. Mathe, W. D. Roos, Electrochimica Acta, 85 (2012) 411-422.

What is claimed is:

1. A process for producing a lithium-manganese-oxide spinel material, which includes
producing a raw lithium-manganese-oxide (IMO′) material by means of combustion synthesis;
optionally, introducing a dopant capable of enhancing the performance of the LMO spinel material when used as a cathode material in an electrochemical cell;
optionally, subjecting the raw LMO material to microwave treatment, to obtain a treated material;
annealing the raw LMO material or the treated material, to obtain an annealed material; and
optionally, subjecting the annealed material to microwave treatment;
with the proviso that at least one of the microwave treatments takes place, thereby to obtain the lithium-manganese-oxide (LMO) spinel material.

2. The process according to claim 1, wherein the combustion synthesis by means of which the raw LMO material is produced is solution combustion synthesis (‘SCS’) comprising subjecting or exposing a homogeneous solution of reactants to an initial high temperature to initiate an exothermic reaction of the reactants throughout the solution, with the raw LMO material being in powdered or granular form.

3. The process according to claim 2, wherein the reactants comprise a lithium compound selected from lithium nitrate, acetate, sulphate and/or carbonate, and a manganese compound selected from manganese nitrate, acetate, sulphate and/or carbonate.

4. The process according to claim 3, wherein water is used as the solvent so that the solution is an aqueous solution.

5. The process according to claim 4, wherein the homogeneous solution includes a combustion aid or fuel for the reaction.

6. The process according to claim 5, which includes dissolving the lithium compound, the manganese compound and the fuel in water, with the initial high or elevated temperature to which the solution is subjected or exposed being at least 500° C.

7. The process according to claim 6, which includes continuing to subject the solution and the raw LMO material or product, as it forms, to the high temperature of at least 500° C. while the exothermic or self-sustaining reaction takes place.

8. The process according to claim 2, wherein the dopant is present, with the process including adding a dissolved aluminium compound to the solution as the dopant.

9. The process according to claim 1, wherein the microwave treatment or irradiation comprises subjecting the raw LMO material and/or the annealed material to microwaves for between 10 and 30 minutes.

10. The process according to claim 1, wherein the annealing of the raw LMO material or the treated material is effected at a temperature from 600° C. to 800° C. which is sufficiently high to crystallize the material, with the annealing being effected for 8 to 12 hours to achieve a desired degree of annealing.

11. LMO spinel material when produced by the process of claim 1.

12. An electrochemical cell, which includes a cell housing, a cathode, an anode and an electrolyte in the cell housing, in which the cathode is electronically insulated from the anode but electrochemically coupled thereto by the electrolyte, the cathode comprising the LMO spinel material of claim 11.

13. An electrochemical cell according to claim 12, wherein the cell housing, cathode, anode and electrolyte are arranged to permit a charging potential to be applied to the cell to cause lithium from the cathode to form at least part of the anode, and with the cell being such that during charge and discharge hereof, the average manganese valence state is about 3.5+ or higher.

14. A method of making an electrochemical cell, which includes loading, into a cell housing, an electrolyte, an anode and cathode, with the cathode comprising the LMO spinel material of claim 11.

15. A method of operating an electrochemical cell, which method includes
applying a charging potential to the electrochemical cell of the second aspect of the invention, thereby causing lithium from the cathode to form at least part of the anode; and
permitting the discharging potential of the cell to reach 3.5 to 4.3 V vs. lithium metal, and with the average manganese valence state being about 3.5+ or higher during charge and discharge of the cell.
